(19) United States
(12) Patent Application Publication
(10) Pub. No.: US 2004/0027245 A1
(43) Pub. Date: Feb. 12, 2004

(54) Portable, self-locating smart defibrillator system

(76) Inventors: Dan Schlager, Tiburon, CA (US); William B. Baringer, Oakland, CA (US)

Correspondence Address: ROBERT BUCKLEY, PATENT ATTORNEY, 462 N M ST., LIVERMORE, CA, 94551-2828, US

(21) Appl. No.: 10/216,033

(22) Filed: Aug. 10, 2002

(51) Int. Cl. G08B 23/00

(52) U.S. Cl. 340/573.1

(57) ABSTRACT

The present invention incorporates a satellite global positioning receiver and a radio transmitter into a smart defibrillator. The defibrillator is modified so that the detection of an irregular heart rhythm provides a signal for activating the radio transmitter for transmitting the global location to a base receiver, typically located in an emergency room. In a specific embodiment, the satellite global receiver relies upon the U.S. Global Positioning System (“GPS”), and the radio transmitter is provided by a wireless telephone.

### RELATED DOCUMENTS

The present invention is related to, and incorporates by reference the full disclosures of U.S. Pat. No. 5,461,365, 5,650,770, 5,963,130, and 6,198,390, and of co-pending U.S. patent application Ser. No. 09/728,167, filed Dec. 1, 2000.

### FIELD OF THE INVENTION

The invention relates to personal alarm systems, and in particular to personal alarm systems that provide user location when a smart defibrillator is activated.

### BACKGROUND ART

A defibrillator, as used herein, is a device used in emergency medicine to apply controlled electrical shock to some portion of a patient's body, usually the chest area, for the purpose of restarting the heart or for stabilizing an irregular heart rhythm. Typically the defibrillator includes a power supply, control circuits, a circuit for developing and storing a high energy electrical charge, and a pair of paddles connected to the high energy circuit via insulated cables. In use, the clothing is cleared from the patient's chest area, the control circuits activate the high energy circuit, the paddles are pressed against opposed regions of the chest, and a switch connects the high energy charge to the paddles.

Recently, automatic (“smart”) defibrillators have been introduced which include a heart rhythm monitoring circuit used to control the energy of the charge applied to the patient depending upon the presence or absence of particular irregular heart rhythms. The additional circuit monitors a patient's heart rhythm through an electrical circuit via the paddles placed against the chest.

A need exists for providing an accurate global location of the patient to an emergency room at the time defibrillation is attempted in the field by emergency personnel.

### SUMMARY OF THE INVENTION

The need is met by the present invention which incorporates a satellite global positioning receiver and a radio transmitter into a smart defibrillator. The defibrillator is modified so that the detection of an irregular heart rhythm provides a signal for activating the radio transmitter for transmitting the global location to a base receiver. In a specific embodiment, the satellite global receiver relies upon the U.S. Global Positioning System (“GPS”), and the radio transmitter is provided by a wireless telephone.

### BRIEF DESCRIPTION OF THE DRAWINGS

FIG. 1 is a block diagram illustrating a portable, self-locating smart defibrillator system according to one aspect of the present invention.

FIG. 2 is a block diagram that illustrates an alternative embodiment of the system of FIG. 1.

FIG. 3 is a partial block diagram of another embodiment of the invention.

### DESCRIPTION OF THE PREFERRED EMBODIMENTS

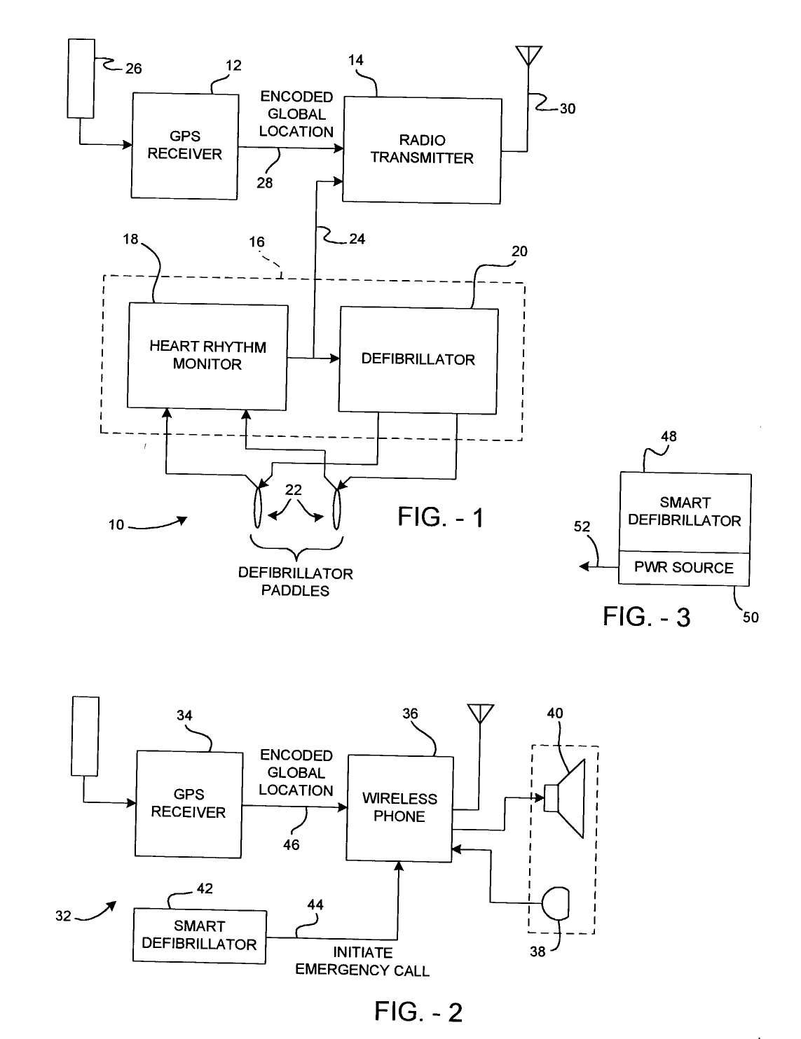

FIG. 1 is a block diagram illustrating a portable, self-locating smart defibrillator system according to one aspect of the present invention, and designated generally by the numeral 10. The system 10 includes a satellite global positioning receiver 12, a radio transmitter 14, and a smart defibrillator 16 (enclosed by a broken line). The smart defibrillator 16 includes a heart rhythm monitor 18 and a defibrillator 20. The system 10 is self-contained, and in a specific embodiment is portable and is battery operated (not shown). Smart defibrillators are known in the emergency medical field, e.g., the Heartstream™ automatic defibrillator from Heartstream of Seattle, Wash., and the Lifepack 5™ automatic defibrillator from Physiocontrol, also of Seattle, Wash. In another specific embodiment (not illustrated) the defibrillator does not include a heart rhythm monitor.

Both the heart rhythm monitor 18 and the defibrillator 20 make connection with the patient's body via a pair of defibrillator paddles 22. When the paddles 22 are placed against opposed regions of the patient's chest and electrical connection is established through the skin to the heart rhythm monitor 18. The monitor determines whether to apply defibrillation, and generates a signal 24 which triggers the defibrillator 20 and causes the radio transmitter 14 to transmit the patient's global location.

The satellite global positioning receiver 12 uses an antenna 26 for receiving global positioning information from satellites in geo-synchronous orbit. The receiver 12 provides a global location in encoded form 28 to the radio transmitter 14 for transmission of the patient's location.

The radio transmitter 14 uses an antenna 30 for transmitting the location. Base stations suitable for use with the present invention are illustrated and described in the references which are incorporated by reference, e.g., base stations 200 of FIG. 6, 318 of FIG. 11, 354 of FIG. 12, and 554 of FIG. 18, all part of U.S. Pat. No. 5,650,770. See also bases stations 754 of FIG. 21, and 1184 of FIG. 34 of U.S. Pat. No. 5,963,130.

FIG. 2 is a block diagram that illustrates an alternative embodiment of the system 10 of FIG. 1. The alternative system is designated generally by the numeral 32 and includes a GPS receiver 34, a wireless phone 36 having a microphone 38, and an ear speaker 40. The system 32 also includes a smart defibrillator 42, as described above with respect to the smart defibrillator 16 of FIG. 1. The paddles and heart rhythm monitor are not shown, but are part of the smart defibrillator 42.

When the heart rhythm monitor triggers the defibrillator, a signal 44 is generated by the monitor which is used by the wireless phone to initiate an emergency call. Once the emergency call has been initiated, the wireless phone transmits the patient's global location provided in encoded form 46 by the GPS receiver 34. The microphone 38 and the ear speaker 40 are used for two-way voice communication with a receiving base station (not shown).

In an alternative embodiment (not illustrated), a navigational receiver provides calculated time delay of arrival location information to the radio transmitter for transmission of the patient's location. Such a navigational system is disclosed in U.S. Pat. No. 5,548,583 to Bustamante, issued Aug. 20, 1996, entitled “Wireless Telephone User Location Capability for Enhanced 911 Application”, the full disclosure of which is incorporated herein by reference.

FIG. 3 is a partial block diagram of another alternative embodiment of the invention in which the smart defibrillator 48 includes a portable power source 50, usually a battery. The portable power source 50 is used by the satellite global positioning receiver and the radio transmitter/wireless phone for operating power 52.

There are some defibrillators that are semi-automatic (also called “automatic”). What that means is the machine reads the rhythm of the victim and decides if it is a rhythm that would benefit from electrical shock. This is useful for the public since most of the time it will not be a person capable of reading and understanding the rhythm and knowing whether to shock.

If it is not a rhythm that would benefit from defibrillation, it won't shock, however, it still may be important for the rescue person to make the call for help and to transmit location.

Alternatively, since these defibrillators are expected to be ubiquitous, they may be useful in another capacity as a callbox. i.e. call for help for a broken leg where there is no need for defibrillation. So one embodiment is more as just a portable callbox and not as a defibrillator.

While the invention has been described in relation to the embodiments shown in the accompanying Drawing figures, other embodiments, alternatives and modifications will be apparent to those skilled in the art. It is intended that the Specification be exemplary only, and that the true scope and spirit of the invention be indicated by the following Claims.

1. A personal alarm system remote unit, comprising:
radio transmitting means for communication with a base station;
a defibrillator having electrical contacts for applying an electrical shock to the body of a user; and
the defibrillator connected to the radio transmitting means for causing the transmission of an alarm for help when the defibrillator is activated for delivering the shock.

2. The remote unit of claim 1, further including radio receiving means permitting two-way radio communication with the base station.

3. The remote unit of claim 1, further including a manually operated push button for activating the defibrillator and causing the radio transmission of an alarm for help.

4. The remote unit of claim 1, further including voice activation means connected for activating the defibrillator and causing the radio transmission of an alarm for help.

5. The remote unit of claim 1, further including a navigational receiver for providing positional data, and the radio transmitting means is connected for transmitting the positional data when the defibrillator is activated.

6. The remote unit of claim 5, wherein the navigational receiver is a GPS receiver.

7. The remote unit of claim 6, wherein the navigational receiver provides demodulated GPS data.

8. The remote unit of claim 6, wherein the navigational receiver provides calculated time delay of arrival location information.

9. The remote unit of claim 1, wherein the radio transmitting means is a cellular/PCS/radio transmitter.

10. The remote unit of claim 2, wherein the radio receiving means is a cellular/PCS/radio receiver.

11. The remote unit of claim 1, wherein the defibrillator includes a heart rhythm monitor receiving an input from the body of the user via the electrical contacts, and wherein the defibrillator is activated for delivering a shock and initiating transmission of an alarm for help when the monitor detects an irregular heart rhythm.
